(19) United States
(12) Patent Application Publication
(10) Pub. No.: US 2026/0003211 A1
(43) Pub. Date: Jan. 1, 2026

(54) MULTIFOCAL LENS

(71) Applicant: KOREA ELECTRONICS TECHNOLOGY INSTITUTE, Seongnam-si (KR)

(72) Inventor: Soon Hyung KWON, Seongnam-si (KR)

(21) Appl. No.: 19/240,112

(22) Filed: Jun. 17, 2025

(30) Foreign Application Priority Data
Jun. 28, 2024 (KR) 10-2024-0085574
Oct. 25, 2024 (KR) 10-2024-0147821

(51) Int. Cl. G02C 7/06

(52) U.S. Cl. CPC G02C 7/06; G02C 2202/24

(57) ABSTRACT

Disclosed is a multifocal lens including a lens configured such that one surface thereof facing an eye is concave and a liquid crystal layer formed on one surface of the lens, wherein the liquid crystal layer refracts a part of light that has passed through the lens according to an arrangement direction of liquid crystals and gathers the same to the center according to the shape of the one surface of the lens, whereby myopia and hyperopia may be simultaneously corrected with one lens.

### CROSS REFERENCE TO RELATED APPLICATION

The present application claims priority to Korean Patent Application No. 10-2024-0085574, filed Jun. 28, 2024, and Korean Patent Application No. 10-2024-0147821, filed Oct. 25, 2024, the entire contents of which are incorporated herein for all purposes by this reference.

### TECHNICAL FIELD

The present disclosure relates to a multifocal lens.

### BACKGROUND

Eyeglasses are used to correct vision. Myopia is a condition in which distant objects appear blurry. Hyperopia is a condition in which near objects appear blurry. In general, glasses with convex lenses are used to correct hyperopia, and glasses with concave lenses are used to correct myopia. Hyperopia is caused by aging of the eye, and people who are nearsighted may also develop hyperopia as a result of aging. It is very inconvenient for a person with farsightedness due to aging to change glasses every time in order to see a near object or a distant object. Therefore, in order to see a distant object and a near object with one pair of glasses, a lens is divided such that a part thereof has a different refractive power from the remainder, or a focus adjustable system in which lenses with different focal lengths are used separately or simultaneously depending on the distance is used. In the case of spatial division, the focal length changes depending on the direction of viewing, which may cause dizziness, and the refractive difference is visible from the outside, which is not aesthetically pleasing. In the case of the focus adjustable system, it is inconvenient to use because multiple lenses are used alternately.

### SUMMARY

It is an aspect of the present disclosure to provide a lens having a liquid crystal layer formed thereon such that the lens has multiple focal points.

According to an aspect of the present disclosure, a multifocal lens includes a lens configured such that one surface thereof facing an eye is concave and a liquid crystal layer formed on the one surface of the lens, wherein the liquid crystal layer refracts a part of light that has passed through the lens according to an arrangement direction of liquid crystals and gathers the same to the center according to the shape of the one surface of the lens.

According to an embodiment, the lens may be a concave lens configured such that the other surface thereof, which is opposite the one surface thereof, is concave.

According to an embodiment, the liquid crystal layer may be formed on the one surface of the lens so as to have a uniform thickness.

According to an embodiment, the lens may be configured such that the other surface thereof, which is opposite the one surface thereof, is convex and the curvature of the other surface is less than the curvature of the one surface, whereby the lens diverges light.

According to an embodiment, the liquid crystal layer may be formed at a lower part relative to a central axis of the lens, whereby a focal point is formed by light refracted and focused by the liquid crystal layer when the direction of a field of view passes through the liquid crystal layer, and a focal point is formed by the lens when the direction of the field of view passes through a central part of the lens.

According to an embodiment, the curvature of the other surface of the lens, which is opposite the one surface thereof, may be determined such that no refraction of light occurs.

According to an embodiment, the multifocal lens may further include a protective layer formed on the other surface of the liquid crystal layer, which is opposite the one surface of the liquid crystal layer connected to the lens.

According to an embodiment, the multifocal lens may further include a first alignment film formed between the lens and the liquid crystal layer, the first alignment film being configured to align the liquid crystals included in the liquid crystal layer.

According to an embodiment, the multifocal lens may further include a second alignment film formed on the other surface of the liquid crystal layer, which is opposite one surface of the liquid crystal layer connected to the first alignment film, wherein the second alignment film may align the liquid crystals included in the liquid crystal layer.

According to an embodiment, the liquid crystal layer may have a refractive power ranging from 1 to 3 diopter.

According to an embodiment, the multifocal lens may have a size of 2 to 8 cm.

According to an embodiment, the liquid crystal layer may include liquid crystals configured to refract a part of the light that has passed through the lens according to an arrangement direction thereof and a binder configured to fix the liquid crystals in the state in which the liquid crystals are arranged in a predetermined direction.

According to an embodiment, the liquid crystal layer may further include a plurality of capsules each comprising the liquid crystals and the binder.

According to an embodiment, the plurality of capsules may be formed on the one surface of the lens as a layer.

According to an embodiment, the lens may be made of a film with no refractive power, and an adhesive layer configured to be adhered to an external lens may be further formed on the other surface of the lens.

The features and advantages of the present disclosure will be more clearly understood from the following detailed description taken in conjunction with the accompanying drawings.

It should be understood that the terms used in the specification and appended claims should not be construed as being limited to general and dictionary meanings, but should be construed based on meanings and concepts according to the spirit of the present disclosure on the basis of the principle that the inventor is permitted to define appropriate terms for the best explanation.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1A is a view illustrating a multifocal lens according to an embodiment;

FIG. 1B is a view showing the arrangement of liquid crystals in a liquid crystal layer according to an embodiment;

FIG. 2 is a view illustrating a multifocal lens including a concave-concave lens according to an embodiment;

FIG. 3 is a view illustrating an embodiment and a comparative example in each of which a myopic person develops hyperopia due to presbyopia;

FIG. 4 is a view illustrating a concave-convex lens according to an embodiment;

FIG. 5 is a view illustrating the focus of a multifocal lens having a partially formed liquid crystal layer according to an embodiment when viewing a distant object;

FIG. 6 is a view illustrating the focus of the multifocal lens having the partially formed liquid crystal layer according to the embodiment when viewing a near object;

FIG. 7 is a view showing a multifocal lens including a lens with no refractive power according to an embodiment;

FIG. 8 is a view showing a multifocal lens including a lens with no refractive power and a protective layer according to an embodiment;

FIG. 9 is a view showing a multifocal lens including a concave lens and a protective layer according to an embodiment;

FIG. 10 is a view showing a multifocal lens further including an alignment film according to an embodiment;

FIG. 11 is a view showing a multifocal lens further including a second alignment film according to an embodiment;

FIG. 12 is a view showing a multifocal lens having a partially formed liquid crystal layer and further including an alignment film according to an embodiment;

FIG. 13 is a view showing a multifocal lens further including a capsule including liquid crystals in a liquid crystal layer according to an embodiment;

FIG. 14 is a view illustrating a multifocal lens attachable to an eyeglass lens according to an embodiment; and

FIG. 15 is a view illustrating a multifocal lens attachable to a part of an eyeglass lens according to an embodiment.

### DETAILED DESCRIPTION

Hereinafter, the present disclosure will be described in detail (with reference to the accompanying drawings). However, this is by way of example only, and the present disclosure is not limited to a specific embodiment described as an example.

Hereinafter, an embodiment of the present disclosure will be described in detail with reference to the accompanying drawings.

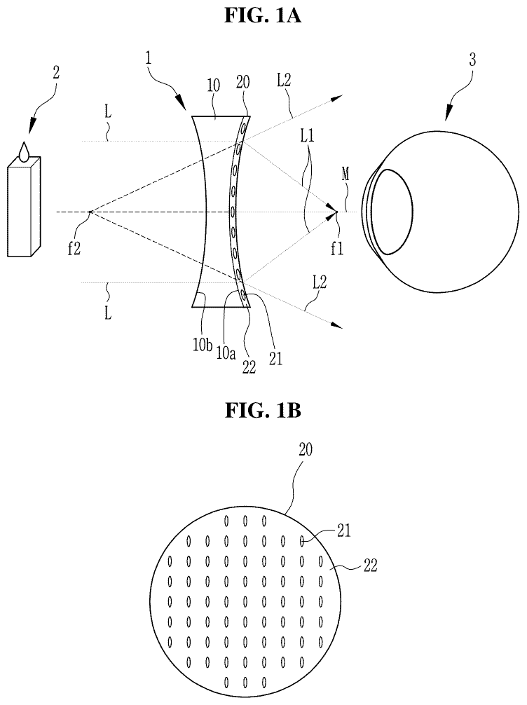

FIG. 1A is a view illustrating a multifocal lens 1 according to an embodiment. FIG. 1B is a view showing the arrangement of liquid crystals 21 in a liquid crystal layer 20 according to an embodiment.

According to the embodiment, the multifocal lens 1 may include a lens 10 configured such that one surface thereof facing an eye 3 is concave and a liquid crystal layer 20 formed on one surface 10a of the lens 10, wherein the liquid crystal layer 20 may refract a part L1 of light that has passed through the lens 10 according to the direction in which liquid crystals 21 are arranged and gather the same to the center according to the shape of one surface 10a of the lens 10.

The lens 10 may be a concave lens used to correct myopia. The lens 10 may be a concave lens in which one surface facing the eye 3 is concave and the other surface, which is opposite the one surface, is also concave. That is, the lens 10 may be a concave-concave lens.

The liquid crystal layer 20 may include liquid crystals 21 configured to refract light according to the arrangement direction thereof. The plurality of liquid crystals 21 included in the liquid crystal layer 20 may be arranged in a predetermined direction. Light passing through the liquid crystal layer 20 may be partly refracted and partly unrefracted depending on the arrangement direction of the liquid crystals 21. For example, depending on the arrangement direction of the liquid crystals 21, light with a first directional polarization may be refracted and light with a second directional polarization may not be refracted. Here, the polarization may be a linear polarization or an elliptical (circular) polarization. In other words, light oscillating in a first direction may be refracted by the liquid crystal 21, and light oscillating in a second direction may not be refracted. Depending on the arrangement direction of the liquid crystals 21, a part of the light that has passed through the lens 10 may be refracted. Depending on the arrangement direction of the liquid crystal 21, other parts of the light that has passed through the lens 10 may not be refracted.

The liquid crystal layer 20 according to the embodiment is different from a typical polarizer film. A polarizer allows light polarized in a specific direction to pass therethrough and blocks the remaining light. The liquid crystal layer 20 may allow all of the light that has passed through the lens 10 to pass therethrough. The liquid crystal layer 20 allows a part of the light to pass therethrough with refraction and allows the rest of the light to pass therethrough without refraction.

The liquid crystal layer 20 may include liquid crystals 21 configured to refract a part of the light that has passed through the lens 10 according to the arrangement direction thereof and a binder 22 configured to fix the liquid crystals 21 in the state in which the liquid crystals 21 are arranged in a predetermined direction. The binder 22 may include a reactive mesogen (RM) material. The reactive mesogen material may be cured when irradiated with ultraviolet light or when heat is applied. The liquid crystal layer 20 may be manufactured by applying a mixture of the reactive mesogen material and the liquid crystals 21 to one surface 10a of the lens 10 and curing the reactive mesogen material using ultraviolet light or the like in the state in which the liquid crystals 21 are aligned in a predetermined arrangement as the result of application of a magnetic field. Once the reactive mesogen material is cured, the liquid crystals 21 may be fixed in the predetermined arrangement.

The liquid crystals 21 may be arranged in one direction. In FIGS. 1A and 1B, the liquid crystals 21 are arranged in a predetermined direction. The predetermined direction may be a direction in which long axes of the liquid crystals 21 are arranged so as to be parallel to one surface of the liquid crystal layer 20 and the plurality of liquid crystals 21 is arranged side by side. Referring to FIG. 1B, which shows the liquid crystal layer 20 when viewed from the front, it can be seen that the long axes of the liquid crystals 21 are arranged side by side. Referring to FIG. 1A, which shows the liquid crystal layer 20 when viewed from the side, it can be seen that the long axes of the liquid crystals 21 are arranged parallel to one surface of the liquid crystal layer 20. The liquid crystal layer 20 has the same curve as one surface 10a of the lens 10. When the liquid crystal layer 20 is viewed from the side, therefore, the plurality of liquid crystals 21 may be generally arranged so as to have the same curve as one surface 10a of the lens 10.

Although FIGS. 1A and 1B show the arrangement direction of the liquid crystals 21, the liquid crystals 21 may be arranged in other directions, since it is sufficient for the long axes of the liquid crystals 21 to be aligned in a specific direction. For example, the long axes of the liquid crystals 21 may be arranged in a direction perpendicular to one surface 10a of the lens 10. Alternatively, the long axes of the liquid crystals 21 may be arranged at a predetermined angle to one surface 10a of the lens 10. If the liquid crystals 21 of the liquid crystal layer 20 are arranged in a predetermined direction, the liquid crystals may refract a part of the light that can be refracted in that arrangement and allow the rest of the light to pass therethrough, thereby concentrating a part of the light and allowing the rest of the light to pass therethrough as described above.

The liquid crystal layer 20 may be formed on one surface 10a of the lens 10 so as to have a uniform thickness. Since the liquid crystal layer 20 is formed on one surface 10a of the lens 10, the liquid crystal layer may be formed so as to have a curvature equal to the curvature of one surface 10a of the lens 10. Since the liquid crystal layer 20 is formed along one surface 10a of the lens 10, the liquid crystal layer is curved. The liquid crystal layer 20 may refract a part L1 of the light that has passed through the lens 10 and focus the same along the curve of one surface 10a of the lens 10 so as to be gathered toward a center line M of the lens 10. In other words, the liquid crystal layer 20 is curved at a predetermined curvature, and therefore the light L1 refracted by the liquid crystals 21 may be gathered toward the center line M of the lens 10.

Since the liquid crystal layer 20 is formed on one surface 10a of the lens 10, the liquid crystal layer may be formed so as to have a curve of the same curvature as the curvature of one surface 10a of the lens 10. If the curvature of one surface 10a of the lens 10 is large, the liquid crystal layer 20 may collect more light. That is, the larger the curvature of one surface 10a of the lens 10, the larger the refractive power of the liquid crystal layer 20. The refractive power of the liquid crystal layer 20 may be applied to the light L1 refracted by the liquid crystal 21. The light L2 that has not been refracted by the liquid crystal layer 20 may pass therethrough unchanged and may not be focused toward the center line M of the lens 10.

The liquid crystal layer 20 according to the embodiment may have a refractive power ranging from 1 to 3 diopter (D). The unit of refractive power is diopter. The refractive power may indicate the degree to which the liquid crystal layer 20 focuses light. The higher the refractive power, the more light may be focused. The light L1 refracted by the liquid crystal layer 20 may be focused by the refractive power ranging from 1 to 3 diopter. In order to form a liquid crystal layer 20 having a desired refractive power, the curvature of the curve of one surface 10a of the lens 10 may be determined.

The size of the multifocal lens 1 may be 2 to 8 cm. The multifocal lens 1 may be manufactured in a size for use in an eyeglass lens 10.

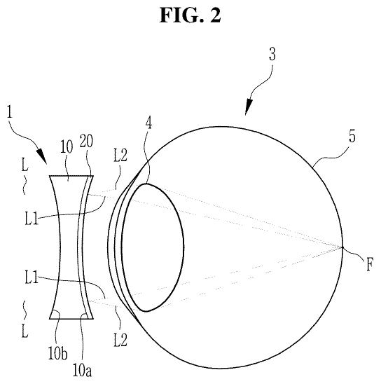

FIG. 2 is a view illustrating a multifocal lens 1 including a concave-concave lens 10 according to an embodiment. Reference is also made to FIG. 1A. A method of correcting myopia and hyperopia using the multifocal lens 1 according to the embodiment will be described with reference to FIGS. 1A and 2.

In FIG. 1A, light L reflected by an object 2 may pass through the lens 10 and enter the liquid crystal layer 20.

The liquid crystal layer 20 may refract a part L1 of the light. The light L1 refracted by the liquid crystal layer 20 may be focused toward the center line M of the lens 10.
The light L2 that has not been refracted by the liquid crystal layer 20 may be diverged away from the center line M depending on the refractive power of the lens 10. The light L1 that is focused toward the center line M may form a first focal point f1. The first focal point f1 may be located in the direction toward one surface 10a of the lens (i.e., the direction toward the eye 3). The light L2 diverged from the center line M may form a second focal point f2. The second focal point f2 may be located in the direction toward the other surface 10b of the lens 10 (i.e., the direction toward the object 2). In FIG. 1A, the second focal point F2 is indicated by a dashed line.

In FIG. 2 when the multifocal lens 1 according to the embodiment is located in front of the eye 3, the light L2 that has not been refracted by the liquid crystal layer may be diverged by the lens 10, which is a concave lens, and pass through a crystalline lens 4 of the eye to form a focal point F on the retina 5. That is, the user may comfortably see a distant object 2. The light L1 refracted by the liquid crystal layer 20 may be focused by the liquid crystal layer 20 and pass through the crystalline lens 4 of the eye to form a focus F on the retina 5. That is, the user may comfortably see a near object 2.

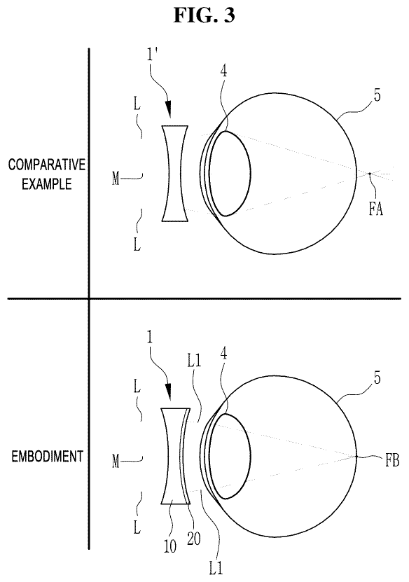

FIG. 3 is a view illustrating an embodiment and a comparative example in each of which a myopic person develops hyperopia due to presbyopia. Reference is also made to FIGS. 1A and 2.

Eyeglasses are commonly used to correct myopia. In order to correct myopia, concave lenses are used. People with myopia may develop hyperopia as they age. A person with nearsightedness who develops farsightedness may be able to see a distant object 2 well with concave lenses, but may have difficulty seeing a near object 2. The multifocal lens 1 according to the embodiment may be used to simultaneously correct both myopia and hyperopia.

The comparative example shows a person with nearsightedness, who has developed more hyperopia due to aging, viewing a near object 2 with corrected vision using concave lens glasses. In the comparative example, the light L reflected by the object 2 may be diverged while passing through a concave lens 1′ and focused toward the center line M of the lens 10 while passing through the crystalline lens 4 of the eye. However, since the eye 3 has hyperopic symptoms, a focal point FA may be formed behind the retina 5. In order to improve the hyperopic symptoms, the lens 10 must gather the light L toward the center line M, which is difficult to do with the concave lens 1′ alone. Therefore, the hyperopic symptoms are difficult to correct with the concave lens 1′.

On the other hand, in the multifocal lens 1 according to the embodiment, the liquid crystal layer 20 formed on one surface of the concave lens may focus a part L1 of the light toward the center line M. The light L1 refracted by the liquid crystal layer may be focused by the curve of the liquid crystal layer 20, and can be focused once more by the crystalline lens 4 to form a focal point FB on the retina 5. Therefore, both hyperopia and myopia of a person who has myopia and has developed more hyperopia due to aging may be simultaneously corrected using the multifocal lens 1 according to the embodiment.

When wearing glasses using one multifocal lens 1, a focal point by the unrefracted light L2 may be formed on the retina 5 when the user focuses on a distant object, and a focal point by the refracted light L1 may be formed on the retina 5 when the user focuses on a near object. Thus, the user may comfortably view distant and near objects with one pair of glasses.

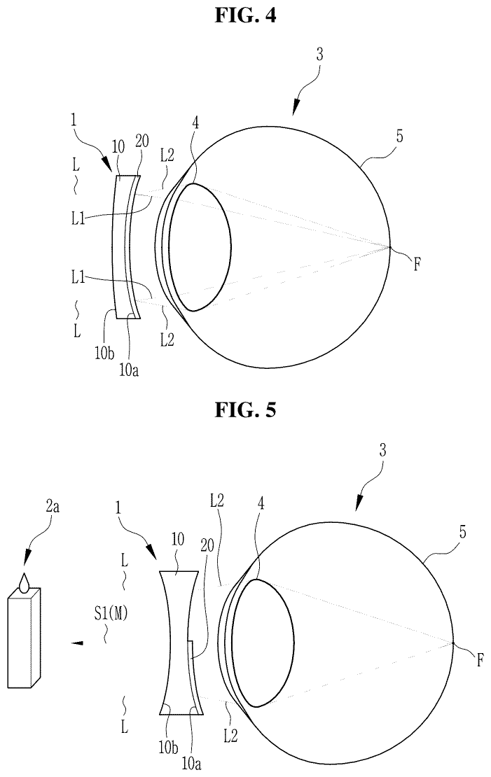

FIG. 4 is a view illustrating a concave-convex lens 10 according to an embodiment.

A lens 10 that diverges light, such as a concave lens, may be configured such that one surface 10a is concave and the other surface 10b is convex. However, the edge of the lens 10 needs to be formed thicker than the center. As shown in FIG. 4, the lens 10 may be configured such that one surface 10a facing the eye 3 is concave, the other surface 10b, which is opposite the one surface, is convex, and the curvature of the other surface 10b is less than the curvature of one surface 10a, whereby the lens may diverge light. If the curvature of the other surface 10b is less than the curvature of one surface 10a, the edge of the lens 10 may be formed thicker than the center thereof, whereby light may be diverged like a concave-concave lens.

In the multifocal lens 1 according to the embodiment, the liquid crystal layer may be formed on the concave surface 10a rather than the convex surface 10b of the lens 10. Similarly to what has been described with reference to FIGS. 1 to 3, in the light that has passed through the lens 10, the unrefracted light L2 may be diverged by the lens 10, and the refracted light L1 may be focused toward the center by the liquid crystal layer 20. Therefore, when one surface 10a of the lens 10 is concave and the liquid crystal layer 20 is formed on one surface 10a even if the other surface 10b of the lens 10 is convex, this may be included in the multifocal lens 1 according to the embodiment.

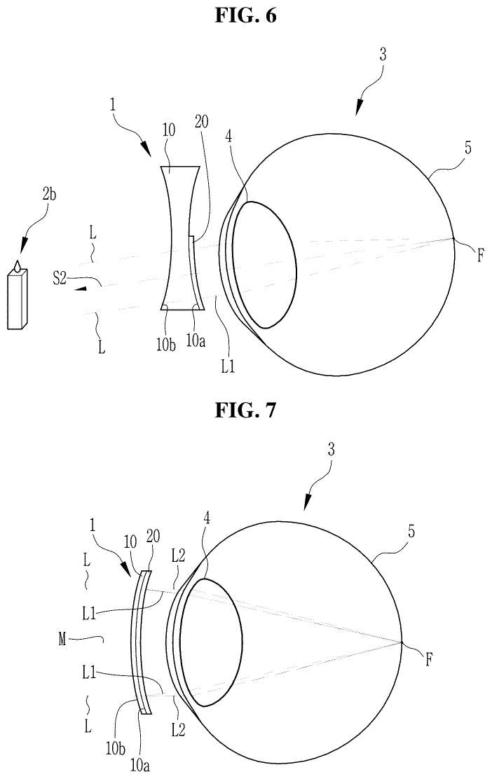

FIG. 5 is a view illustrating the focus of a multifocal lens 1 having a partially formed liquid crystal layer 20 according to an embodiment when viewing a distant object 2a. FIG. 6 is a view illustrating the focus of the multifocal lens 1 having the partially formed liquid crystal layer 20 according to the embodiment when viewing a near object 2b.

According to the embodiment, the liquid crystal layer 20 may be formed at a lower part relative to the center line M of the lens 10. However, depending on the application, the position of the part where the liquid crystal layer 20 is formed may be set differently. In general, it can be said that the liquid crystal layer 20 is formed at the lower part because a line of sight S2 (see FIG. 6) moves downward when a person looks at an object 2b (e.g., a book) at a near distance. In other words, the liquid crystal layer 20 may be formed only in a part of the lens 10 in a direction that is convenient for viewing the object 2b at the near distance.

The liquid crystal layer 20 may be formed at the lower part relative to the center line M of the lens 10, and therefore a focal point may be formed by the light refracted by the liquid crystal layer 20 when the direction of the field of view passes through the liquid crystal layer 20 (S2 of FIG. 6). In the case where the direction of the field of view passes through the center of the lens 10 (S1 of FIG. 5), the light L2 that has not been refracted by the liquid crystal layer 20 may be diverged by the lens 10, and therefore a focal point may be formed by the lens 10.

Referring to FIG. 5, when the eye is directed straight ahead along the center of the lens 10 to view the distant object 2a even if the liquid crystal layer 20 is formed only at a part of the lens 10 in a certain direction (S1), the focal point formed on the retina 5 may be formed by the light L2 that has not been refracted by the liquid crystal layer 20. Specifically, the light L2 that has not been refracted by the liquid crystal layer 20 may pass through the crystalline lens 4 of the eye in a state of being diverged by the lens 10, which is a concave lens, to form a focal point on the retina 5. Thus, the distant object 2a may be viewed comfortably.

Referring to FIG. 6, in order to view a near object 2b, the direction of a line of sight S2 moves toward the near object 2b (generally downward). When the line of sight S2 is shifted to view the near object 2b, the center of the line of sight may pass through the liquid crystal layer 20. In this case, the focal point formed on the retina 5 may be formed by the light L1 refracted by the liquid crystal layer 20. A part L1 of the light diverged by the lens 10, which is a concave lens, may be refracted by the liquid crystal layer 20 and pass through the crystalline lens 4 of the eye in a focused state to form a focal point on the retina 5. Thus, the near object 2b may be viewed comfortably.

FIG. 7 is a view showing a multifocal lens 1 including a lens 10 with no refractive power according to an embodiment.

According to the embodiment, the lens 10 may have no refractive power. That is, the lens 10 may be configured such that one surface is concave, the other surface is convex, and the curvature of one surface and the curvature of the other surface are the same. In this structure, the refractive power of the lens 10 may be minimized. Alternatively, the lens 10 may be configured such that one surface 10a is concave and the curvature of the other surface 10b, which is opposite the one surface, is determined such that no refraction of light occurs. Since one surface 10a of the lens 10 is concave, the curvature of the other surface 10b may be formed so as to be less than the curvature of one surface 10a such that light is focused by the curve of the lens 10, whereby light may be diverged to form a lens 10 with an overall refractive power close to zero.

The multifocal lens 1 including the lens 10 having no refractive power may be used to correct the vision of a user with only hyperopic symptoms. Since one surface 10a of the lens 10 is concave, the liquid crystal layer 20 may focus the refracted light L1 toward the center. The light L2 that has not been refracted by the liquid crystal layer 20 may not be focused or diverged because there is no refractive power of the lens 10. That is, the light L2 that has not been refracted by the liquid crystal layer 20 may move straight. Therefore, the light reflected by the distant object 2 may form a good focus on the retina 5. That is, in the absence of myopia, the user may comfortably see the distant object 2 using the light L2 that has not been refracted by the liquid crystal layer 20 even when using the multifocal lens 1 according to the embodiment.

Hyperopic symptoms caused by aging may be corrected using the phenomenon of focusing the refracted light L1. Since the liquid crystal layer 20 can focus the refracted light L1, the light reflected by the near object 2 may be refracted and focused by the liquid crystal layer 20 and pass through the crystalline lens 4 of the eye to form a focal point on the retina 5. Thus, the user may comfortably see the near object 2 using the light L1 refracted by the liquid crystal layer 20.

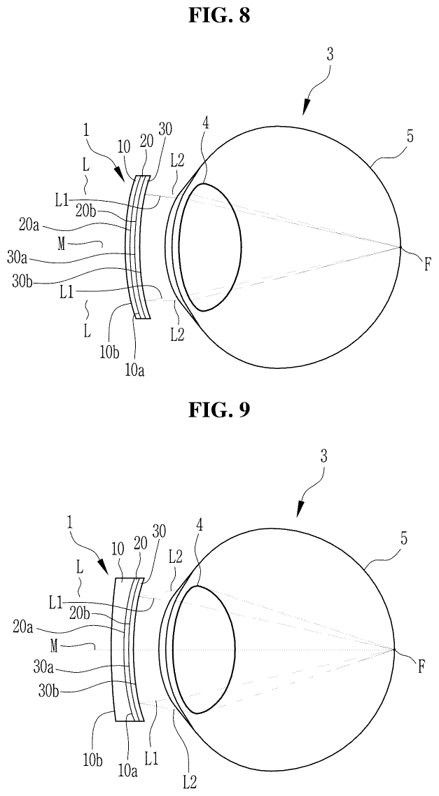

FIG. 8 is a view showing a multifocal lens 1 including a lens 10 with no refractive power and a protective layer 30 according to an embodiment.

The multifocal lens 1 according to the embodiment may further include a protective layer 30 formed on the other surface 20b of the liquid crystal layer 20, which is opposite the one surface 20a of the liquid crystal layer 20 connected to the lens 10. One surface 30a of the protective layer 30 may be connected to the liquid crystal layer 20. The other surface 30b of the protective layer 30 may face the eye 3. The expression “the lens 10 and one surface 20a of the liquid crystal layer 20 are connected to each other” does not exclude other layers being further located between the lens 10 and one surface 20a of the liquid crystal layer 20.

The protective layer 30 may protect the liquid crystal layer 20. The glasses may be subjected to impact during use. Therefore, if the liquid crystal layer 20 is exposed to the outside, impact may cause cracking of the liquid crystal layer 20 or distortion of the arrangement of the liquid crystals 21. In this case, the part of the liquid crystal layer 20 corresponding thereto may break. The protective layer 30 may prevent direct damage to the liquid crystal layer 20. Therefore, the multifocal lens 1 further including the protective layer 30 may be more useful in real life. The protective layer 30 may be made of the same material as the lens 10. The protective layer 30 may be made of glass, a synthetic resin, a film, or various other materials.

FIG. 9 is a view showing a multifocal lens 1 including a concave lens and a protective layer 30 according to an embodiment.

The protective layer 30 may also be included in a multifocal lens 1 including a lens 10 with refractive power. For example, if the multifocal lens 1 shown in FIG. 4 further includes the protective layer 30, the structure shown in FIG. 9 may be formed. Although not shown, the multifocal lens 1 shown in FIG. 2 may further include a protective layer 30.

The protective layer 30 according to the embodiment may have no refractive power, or may form a predetermined refractive power with the lens 10. The refractive power of the multifocal lens 1 including the protective layer 30 having no refractive power may be adjusted by changing the curvature of one surface 10a of the lens 10, the curvature of the other surface 10b of the lens 10, the material of the lens 10, or the arrangement of the liquid crystals 21. Therefore, since relatively few elements are required to design the multifocal lens 1, the design may be easy.

Meanwhile, the lens 10 and the protective layer 30 may be designed to have a refractive power together. If the liquid crystal layer 20 has a uniform thickness, the lens 10 and the protective layer 30 may be considered as a single lens 10 as a whole and the refractive power may be adjusted. The refractive power of the multifocal lens 1 may be adjusted by adjusting the curvature of one surface 10a of the lens 10 connected to the liquid crystal layer 20, the curvature of the other surface 10b of the lens 10, the curvature of the other surface 30b of the protective layer 30, the material of each of the lens 10 and the protective layer 30, or the arrangement of the liquid crystals 21. Designing the lens 10 and the protective layer 30 to have a refractive power together requires more design elements, but has the potential to result in an overall thinner multifocal lens 1 that can be manufactured.

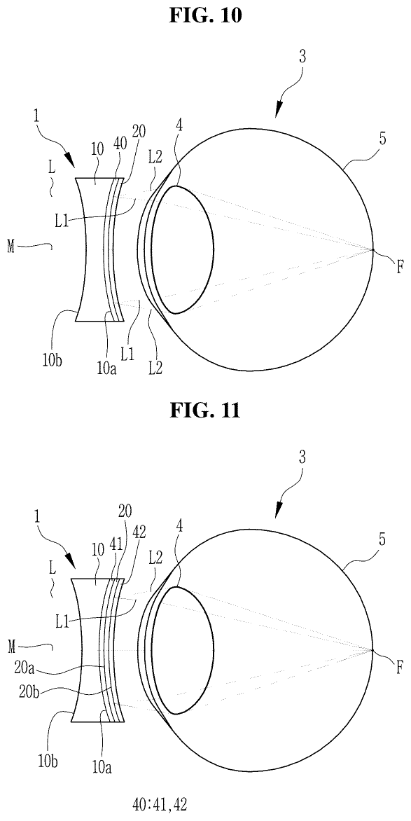

FIG. 10 is a view showing a multifocal lens 1 further including an alignment film 40 according to an embodiment.

The multifocal lens 1 according to the embodiment may further include a first alignment film 40 that is formed between the lens 10 and the liquid crystal layer 20 and that aligns the liquid crystals 21 included in the liquid crystal layer 20. The alignment film 40 may align the liquid crystals 21 included in the liquid crystal layer in a predetermined direction. The alignment film 40 is provided with grooves formed at fine intervals, or compounds capable of holding the liquid crystals 21 at predetermined intervals are arranged in the alignment film 40. When the liquid crystal 21 comes into contact with the alignment film 40, the liquid crystal 21 may be aligned in a direction guided by the alignment film 40.

The liquid crystals 21 may be located in a randomized arrangement when suspended in a fluid, in which case refraction may occur in a randomized polarization component. The liquid crystal layer 20 needs to be maintained such that the liquid crystals 21 have a predetermined arrangement in order to refract light of a predetermined polarization component. The multifocal lens 1 according to the embodiment may use the alignment film 40 to fix the direction of the liquid crystals 21 in order to maintain the direction of the liquid crystals 21 in a fixed arrangement.

The alignment film 40 may be formed by applying a material that determines the direction of the lens to one surface 10a of the lens 10 by spin coating, etc. Alternatively, the alignment film 40 may be formed by applying a material that determines the direction of the lens to a base film.

FIG. 11 is a view showing a multifocal lens 1 further including a second alignment film 42 according to an embodiment.

The multifocal lens 1 according to the embodiment may further include a second alignment film 42 formed on the other surface 20b of the liquid crystal layer 20, which is opposite the one surface 20a of the liquid crystal layer 20 connected to a first alignment film 41, wherein the second alignment film 42 may align the liquid crystals 21 included in the liquid crystal layer 20.

The second alignment film 42 may be formed on the other surface 20b of the liquid crystal layer 20. Since the liquid crystal layer 20 is located between the first alignment film 41 and the second alignment film 42, the liquid crystals 21 of the liquid crystal layer 20 may be aligned in an arrangement determined by the first alignment film 41 and the second alignment film 42. The direction in which the second alignment film 42 aligns the liquid crystals 21 may be the same as the direction in which the first alignment film 41 aligns the liquid crystals 21. The direction in which the first alignment film 41 and the second alignment film 42 align the liquid crystal 21 may affect the refractive power of the liquid crystal layer 20. The alignment direction of the first alignment film 41 and the alignment direction of the second alignment film 42 may be determined by the overall design of the multifocal lens 1 so as to exhibit a desired refractive power.

The first alignment film 41 may be formed by applying a material that determines the direction of the lens to one surface 10a of the lens 10 by spin coating, etc. The first alignment film 41 or the second alignment film 42 may be formed by applying a material that determines the direction of the lens to a base film. The second alignment film 41 may be disposed such that the surface to which a material that determines the direction of the liquid crystals has been applied faces the liquid crystal layer 20.

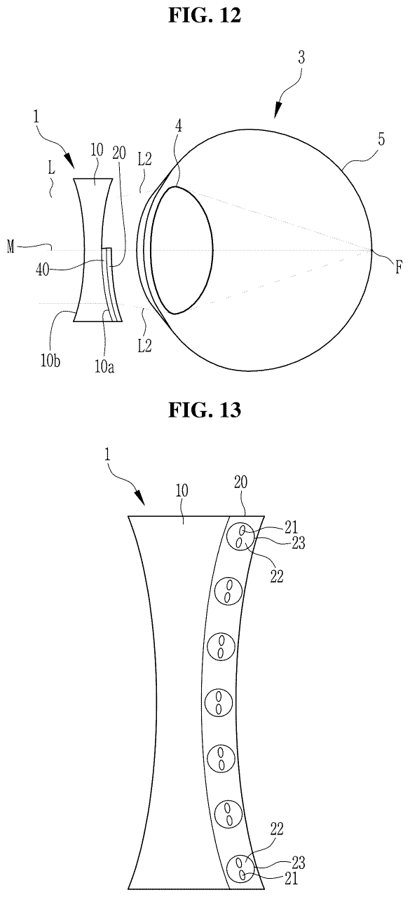

FIG. 12 is a view showing a multifocal lens 1 having a partially formed liquid crystal layer 20 and further including an alignment film 40 according to an embodiment.

When the liquid crystal layer 20 is formed only on a part of the lens 10, the alignment film 40 may also be formed only on a part of the lens 10. The alignment film 40 formed only on a part of the lens 10 may align the liquid crystals 21 of the liquid crystal layer 20 connected to the alignment film 40. Similarly to the second alignment film 42 shown in FIG. 11, a second alignment film (not shown) may be further formed on the other surface of the liquid crystal layer 20.

FIG. 13 is a view showing a multifocal lens 1 further including a capsule 23 including liquid crystals 21 in a liquid crystal layer 20 according to an embodiment.

The liquid crystal layer 20 according to the embodiment may further include a plurality of capsules 23 each including liquid crystals 21 and a binder 22. The capsule 23 may have a size on the micrometer scale. The plurality of capsules 23 may be formed on one surface 10a of the lens 10 as a layer. The plurality of capsules 23 may be formed as a single layer or as multiple layers. In the single layer, the capsules 23 are located so as not to overlap each other and compactly fill one surface 10a of the lens 10. The multiple layers may be formed by stacking the single layer multiple times. The layers may be thick layers of such thickness that the capsules 23 can be formed as multiple layers. When the process of manufacturing the liquid crystal layer is performed in the state in which the liquid crystals 21 and the binder 22 are injected into each capsule 23, the liquid crystal 21 may be handled in the capsule unit. Applying the uniformly sized capsules 23 as a single layer enables uniform placement of the liquid crystals 21 in the liquid crystal layer 20, thereby achieving optical uniformity. The liquid crystal layer 20 may further include an additional binder material configured to fix the capsules 23. A material that is cured by ultraviolet light or the like may be used as the additional binder material.

The plurality of liquid crystals 21 included in the plurality of capsules 23 may be generally arranged in a predetermined direction. The plurality of liquid crystals 21 may be arranged in the first direction, as shown in FIG. 1B, and may be arranged in a direction in which the long direction of the liquid crystals 21 is parallel to one surface 10a of the lens 10, as shown in FIG. 13.

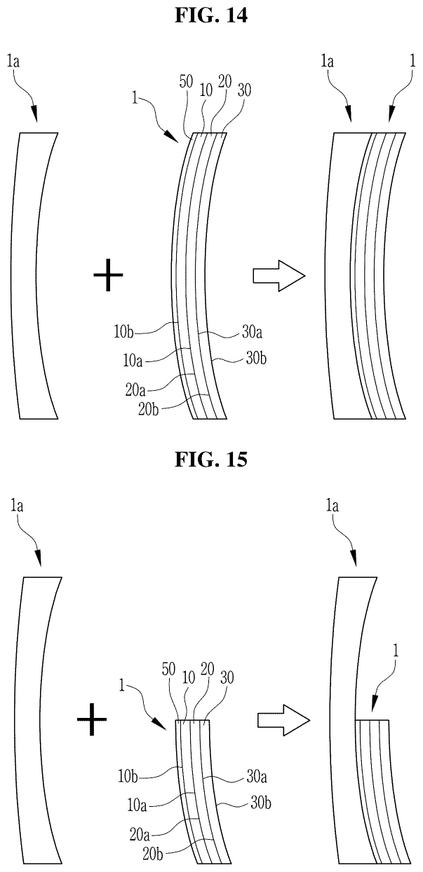

FIG. 14 is a view illustrating a multifocal lens 1 attachable to an eyeglass lens 1a according to an embodiment.

According to the embodiment, a multifocal lens 1 attachable to an eyeglass lens 1a may be provided. The lens 10 of the multifocal lens 1 according to the embodiment may be made of a film with no refractive power, and an adhesive layer 50 that can be adhered to an external lens (e.g., the eyeglass lens 1a) may be further formed on the other surface 10b of the lens 10. The eyeglass lens 1a, which is an external lens, may be a concave lens used to correct myopia.

According to the embodiment, the multifocal lens 1 may include a lens 10 configured such that one surface 10a facing the eye is concave, a liquid crystal layer formed on one surface 10a of the lens 10, a protective layer 30 formed on the other surface 20b of the liquid crystal layer 20, which is opposite the one surface 20a of the liquid crystal layer 20 connected to the lens 10, and an adhesive layer 50 formed on the other surface 10b of the lens 10, the adhesive layer being capable of being adhered to the external lens.

The curvature of the other surface 10b of the lens 10 may be manufactured differently depending on the curvature of the eyeglass lens 1a to be attached. The curvature of one surface 10a of the lens 10 may be manufactured with different curvatures depending on the degree of hyperopia to be corrected. If the curvature of the other surface 10b of the lens 10 and the curvature of one surface 10a of the lens 10 are different, causing the lens 10 to have a refractive power, the curvature of one surface 30a and the other surface 30b of the protective layer 30 may be adjusted such that the multifocal lens 1 has no refractive power. Alternatively, the lens 10 and the protective layer 30 may be designed so as to have a predetermined refractive power.

FIG. 15 is a view illustrating a multifocal lens 1 attachable to a part of an eyeglass lens 1a according to an embodiment.

Similarly to what has been described with reference to FIG. 6, the multifocal lens 1 according to the embodiment may be attached to only a lower part of the eyeglass lens 1a. The multifocal lens 1 according to the embodiment may be attached only to a lower part of the user's existing eyeglass lens 1a. In this case, the multifocal lens 1 may be manufactured so as to be attached only to the lower part of the eyeglass lens 1a based on the center axis of the eyeglass lens 1a.

An adhesive layer 50 may be sold in a state of being temporarily covered by a protective sheet (not shown) or the like, and when the user removes the protective sheet and attaches the multifocal lens 1 to the eyeglass lens 1a, the eyeglass lens 1a and the multifocal lens 1 may be adhered to each other. Since the multifocal lens 1 can be attached to the user's existing myopia correction eyeglasses, there is the advantage of adding a hyperopia correction function while using the user's existing eyeglasses.

As is apparent from the above description, according to an embodiment of the present disclosure, a wearer of eyeglasses using a multifocal lens may comfortably focus on both distant and near objects.

According to an embodiment of the present disclosure, a person who is nearsighted may correct hyperopia due to aging with a single pair of glasses.

According to an embodiment of the present disclosure, a bifocal lens may be provided.

According to an embodiment of the present disclosure, a trifocal lens may be provided.

The present disclosure has been described in detail with reference to the specific embodiment. The above description is merely an example of applying the principles of the present disclosure, and other configurations may be included without departing from the scope of the present disclosure.

What is claimed is:

1. A multifocal lens comprising:
a lens configured such that one surface thereof facing an eye is concave; and
a liquid crystal layer formed on the one surface of the lens, wherein
the liquid crystal layer refracts a part of light that has passed through the lens according to an arrangement direction of liquid crystals and gathers the same to a center according to a shape of the one surface of the lens.

2. The multifocal lens according to claim 1, wherein the lens is a concave lens configured such that the other surface thereof, which is opposite the one surface thereof, is concave.

3. The multifocal lens according to claim 1, wherein the liquid crystal layer is formed on the one surface of the lens so as to have a uniform thickness.

4. The multifocal lens according to claim 1, wherein the lens is configured such that the other surface thereof, which is opposite the one surface thereof, is convex and a curvature of the other surface is less than a curvature of the one surface, whereby the lens diverges light.

5. The multifocal lens according to claim 1, wherein the liquid crystal layer is formed at a lower part relative to a central axis of the lens, whereby a focal point is formed by light refracted and focused by the liquid crystal layer when a direction of a field of view passes through the liquid crystal layer, and a focal point is formed by the lens when the direction of the field of view passes through a central part of the lens.

6. The multifocal lens according to claim 1, wherein a curvature of the other surface of the lens, which is opposite the one surface thereof, is determined such that no refraction of light occurs.

7. The multifocal lens according to claim 1, further comprising a protective layer formed on the other surface of the liquid crystal layer, which is opposite the one surface of the liquid crystal layer connected to the lens.

8. The multifocal lens according to claim 1, further comprising a first alignment film formed between the lens and the liquid crystal layer, the first alignment film being configured to align the liquid crystals included in the liquid crystal layer.

9. The multifocal lens according to claim 8, further comprising:
a second alignment film formed on the other surface of the liquid crystal layer, which is opposite one surface of the liquid crystal layer connected to the first alignment film, wherein
the second alignment film aligns the liquid crystals included in the liquid crystal layer.

10. The multifocal lens according to claim 1, wherein the liquid crystal layer has a refractive power ranging from 1 to 3 diopter.

11. The multifocal lens according to claim 1, wherein the multifocal lens has a size of 2 to 8 cm.

12. The multifocal lens according to claim 1, wherein the liquid crystal layer comprises:
liquid crystals configured to refract a part of the light that has passed through the lens according to an arrangement direction thereof; and
a binder configured to fix the liquid crystals in a state in which the liquid crystals are arranged in a predetermined direction.

13. The multifocal lens according to claim 12, wherein the liquid crystal layer further comprises a plurality of capsules each comprising the liquid crystals and the binder.

14. The multifocal lens according to claim 13, wherein the plurality of capsules is formed on the one surface of the lens as a layer.

15. The multifocal lens according to claim 7, wherein
the lens is made of a film with no refractive power, and
an adhesive layer configured to be adhered to an external lens is further formed on the other surface of the lens.
